(19) United States
(12) Patent Application Publication
(10) Pub. No.: US 2022/0171584 A1
(43) Pub. Date: Jun. 2, 2022

(54) PRINTING APPARATUS, CONTROL METHOD, AND STORAGE MEDIUM

(71) Applicant: CANON KABUSHIKI KAISHA, Tokyo (JP)

(72) Inventor: Ryota Onoguchi, Tokyo (JP)

(21) Appl. No.: 17/522,564

(22) Filed: Nov. 9, 2021

(30) Foreign Application Priority Data
Nov. 27, 2020 (JP) 2020-197652

(51) Int. Cl. G06F 3/12

(52) U.S. Cl. CPC G06F 3/1225; G06F 3/121; G06F 3/1236

(57) ABSTRACT

There is provided a printing apparatus including an update unit. In a case where a setting to enable an automatic update function is received, the update unit automatically updates a predetermined program on the basis that a version of the predetermined program is not a latest version and that a predetermined state where the printing apparatus does not perform a predetermined function continues for a predetermined time. In a case where a setting to disable the automatic update function is received, the update unit does not automatically update the predetermined program.

### BACKGROUND

### Field of the Disclosure

The present disclosure relates to a printing apparatus, a control method, and a storage medium.

### Description of the Related Art

There is known a technique in which a communication apparatus such as a printer acquires information held. by a server to update a program such as firmware, as discussed in Japanese Patent Application Laid-Open No. 2011-186588.

As a configuration for updating a program held by the communication apparatus has become common, it is desired to more appropriately update the program held by the communication apparatus.

### SUMMARY

The present disclosure is directed to performing processing for more appropriately updating a program held by a communication apparatus.

According to an aspect of the present disclosure, a printing apparatus including a predetermined program includes a reception unit configured to receive at least one of a setting to enable an automatic update function or a setting to disable the automatic update function, wherein the automatic update function is a function causing the printing apparatus to automatically update the predetermined program, and an update unit configured to, in a case where the setting to enable the automatic update function is received, automatically update the predetermined program on the basis that a version of the predetermined program is not a latest version and that a predetermined state where the printing apparatus does not perform a predetermined function continues for a predetermined time, and configured to, in a case where the setting to disable the automatic update function is received, not automatically update the predetermined program.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration example of a communication apparatus and a server.

FIG. 2 is a diagram illustrating a configuration of a communication system.

FIG. 3 is a flowchart illustrating processing performed by the communication apparatus and the server.

FIG. 4 is a flowchart illustrating firmware update processing performed by the communication apparatus.

FIG. 5 illustrates a screen displayed in order to receive an input for setting whether to enable or disable an automatic update function.

FIGS. 6A and 6B illustrate screens each displayed on the communication apparatus.

FIGS. 7A to 7D are flowcharts illustrating processing performed by the communication apparatus.

### DESCRIPTION OF THE EMBODIMENTS

Exemplary embodiments of the present disclosure will be described in detail below with reference to the accompanying drawings. The exemplary embodiments described below are not intended to limit the present disclosure according to the scope of the claims, and all combinations of features described in the exemplary embodiments are not necessarily essential for solving means of the present disclosure.

An information processing apparatus and a communication apparatus included in a communication system according to a first exemplary embodiment of the present disclosure will be described. As the information processing apparatus, a server including a personal computer (PC) is described in the present exemplary embodiment. However, the information processing apparatus is not limited thereto. As the information processing apparatus, for example, a smartphone, a mobile terminal, a tablet terminal, a personal digital assistant (PDA), and a digital camera can be used. As the communication apparatus, a printer is described in the present exemplary embodiment. However, the communication apparatus is not limited thereto. Various apparatuses can be used as long as the apparatuses are configured to perform wireless communication with the information processing apparatus and to perform update of firmware. For example, as the printer according to the present exemplary embodiment, an inkjet printer, a full-color laser beam printer, and a monochrome printer can be used. In addition to the printer, a copier, a facsimile (FAX) apparatus, a mobile terminal, a smartphone, a laptop PC, a tablet terminal, a PDA, a digital camera, a music player, a television, and a smart speaker can be used. Furthermore, a multifunction peripheral including a plurality of functions such as a copy function, a FAX function, and a print function can be used.

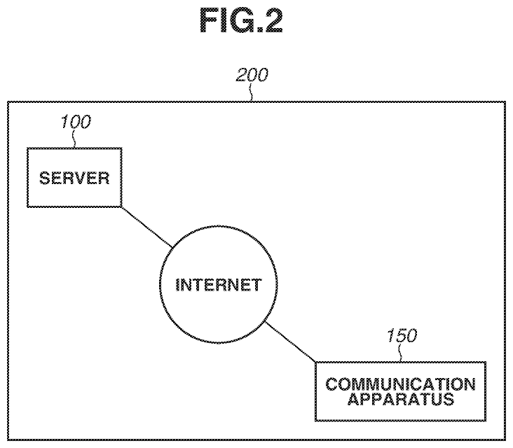

FIG. 2 is a block diagram illustrating a configuration of the communication system according to the present exemplary embodiment. In a communication system 200, a server 100, which is the information processing apparatus according to the present exemplary embodiment, is communicable with a communication apparatus 150, which is the communication apparatus communicable with the information processing apparatus according to the present exemplary embodiment, through the Internet. In the present exemplary embodiment, the server 100 is, for example, a server system including one PC or a plurality of PCs.

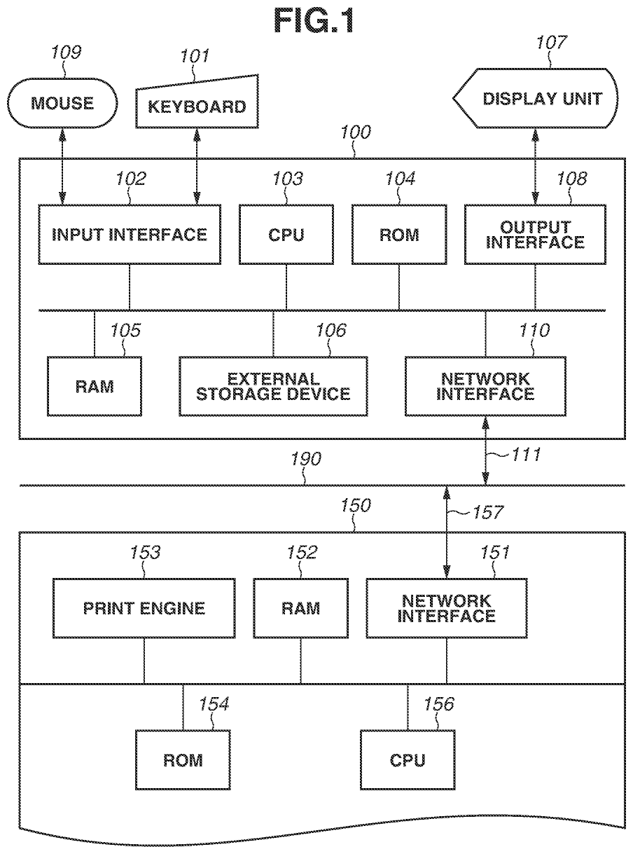

First, configurations of the server 100 and the communication apparatus 150 will be described with reference to a block diagram of FIG. 1. In the present exemplary embodiment, the following configurations are described as an example. However, the present exemplary embodiment is applicable to an apparatus communicable with the communication apparatus, and functions thereof are not particularly limited to those illustrated in FIG. 1.

The server 100 includes an input interface 102, a central processing unit (CPU) 103, a read only memory (ROM) 104, a random access memory (RAM) 105, an external storage device 106, an output interface 108, a display unit 107. a keyboard 101, a mouse 109, and a network interface 110. A computer of the server 100 is formed by the CPU 103, the ROM 104, the RAM 105, and the like.

The network interface 110 is connected to a network 190 through a network cable 111. While in the present exemplary embodiment, the network cable 111 is assumed to be a universal serial bus (USB) cable, the network cable 111 is not limited thereto and may be, for example, a wired local area network (LAN) cable. The network interface 110 may be not connected to the network 190 by a cable, but connected to the network 190 wirelessly. Examples of a wireless communication system used for the wireless connection are a communication system (Wi-Fi) complying with Institute of Electronic and Electronics Engineers (IEEE) 802.11 series. Bluetooth®, and Near-field Communication (NFC). Bluetooth® may be Bluetooth® Classic or Bluetooth® Low Energy. Furthermore, the server 100 may include both an interface connected to the network 190 by a cable and an interface connected to the network 190 wirelessly. In the present exemplary embodiment, the network 190 is assumed to be the Internet network.

The input interface 102 receives a data input or an operation instruction from a user who operates an operation unit such as the keyboard 101 or the mouse 109. The operation unit may be a physical keyboard, physical buttons, or the like, or may be a software keyboard, software buttons, or the like displayed on the display unit 107. In other words, the input interface 102 may receive an input from the user through the display unit 107.

The CPU 103 is a system control unit that controls the entire server 100.

The ROM 104 stores fixed data such as control programs to be executed by the CPU 103, a data table, and an embedded operating system (hereinafter referred to as OS) program. In the present exemplary embodiment, the control programs stored in the ROM 104 perform software execution control such as scheduling, task switching, and interrupt processing under control of the embedded OS stored in the ROM 104.

The RAM 105 includes a static random access memory (SRAM) requiring a backup power supply. A memory area for storing setting information of the server 100, management data of the server 100, and the like is provided in the RAM 105. The RAM 105 is also used as a main memory or a work memory of the CPU 103.

The external storage device 106 stores data (update data) for updating firmware of the communication apparatus 150 and information about the update data. In the firmware update according to the present exemplary embodiment, different pieces of update data are used for different types/models of apparatuses, and the external storage device 106 holds a plurality of different pieces of update data corresponding to different types/models of apparatuses. Furthermore, in the present exemplary embodiment, the update data is the latest firmware, and the communication apparatus 150 having received the update data performs update by replacing the held old firmware with the update data. However, the configuration is not limited thereto. The update data may not be the firmware, and may be data for updating the firmware by correcting a part of the old firmware held by the communication apparatus 150 or by adding a program to the old firmware. The information stored in the external storage device 106 may be stored in any other memory such as the ROM 104.

The output interface 108 controls the display unit 107 to display data and to notify the user of a state of the server 100.

The display unit 107 includes a light-emitting diode (LED) and a liquid crystal display (LCD), and displays data.

The communication apparatus 150 includes a network interface 151, a RAM 152, a print engine 153, a ROM 154, and a CPU 156. A computer of the communication apparatus 150 is formed by the ROM 154, the RAM 152, the CPU 156, and the like.

The network interface 151 is connected to the network 190 through a network cable 157. While in the present exemplary embodiment, the network cable 157 is assumed to be a wired LAN cable, the network cable 157 is not limited thereto and may be a USB cable. The network interface 151 may be not an interface connected to the network 190 by a cable, but an interface connected to the network 190 wirelessly. Examples of a wireless communication system used for the wireless connection are a communication system (Wi-Fi) complying with IEEE 802.11 series. Bluetooth®, and NFC, Bluetooth® may be Bluetooth Classic or Bluetooth® Low Energy. Furthermore, the communication apparatus 150 may include both an interface connected to the network 190 by a cable and an interface connected to the network 190 wirelessly.

The RAM 152 includes an SRAM requiring a backup power supply. A memory area for storing setting information of the communication apparatus 150, management data of the communication apparatus 150, and the like is provided in the RAM 152. The RAM 152 is also used as a main memory or a work memory of the CPU 156, and stores a reception buffer for temporarily storing a print job received from an external PC, a smartphone, or the like, and various kinds of information.

The ROM 154 stores fixed data such as control programs to be executed by the CPU 156, a data table, and an embedded OS program. In the present exemplary embodiment, the control programs stored in the ROM 154 perform software execution control such as scheduling, task switching, and interrupt processing under control of the embedded OS stored in the ROM 154. Furthermore, in the present exemplary embodiment, the ROM 154 stores the firmware of the communication apparatus 150. In the present exemplary embodiment, the firmware of the communication apparatus 150 is a program for controlling various kinds of hardware of the communication apparatus 150.

The CPU 156 is a system control unit that controls the entire communication apparatus 150.

The print engine 153 applies a recording material such as ink to a recording medium such as paper to form an image on the recording medium based on information stored in the RAM 152 or a print job received from an external PC, a smartphone, or the like, thereby outputting a printing result.

A memory such as an external hard disk drive (HDD) or a secure digital (SD) card may be attached as an optional device to the communication apparatus 150, and the information stored in the communication apparatus 150 may be stored in the memory.

While the share of processing between the server 100 and the communication apparatus 150 has been described above as an example, the share is not limited thereto and any other form may be used.

In the present exemplary embodiment, the communication apparatus 150 has a function (an automatic update function) of automatically updating the firmware of the communication apparatus 150 without being based on a user's operation on the communication apparatus 150. For example, assume that the automatic update function is to automatically perform the update at a designated time. In this case, even when the user is using the communication apparatus 150 at the designated time, the update is to be started.

Typically, the functions executable by the communication apparatus 150 are limited during the update. This results in an issue where the user becomes unable to use the communication apparatus 150 due to the update even though the user is using the communication apparatus 150. To address the issue, in the present exemplary embodiment, a configuration for preventing the user from becoming unable to use the communication apparatus 150 due to the update while the user is using the communication apparatus 150 will be described.

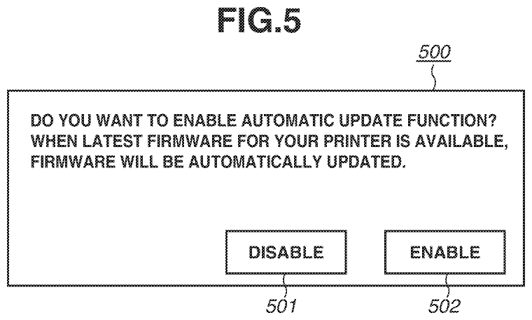

In the present exemplary embodiment, the user can optionally set whether to enable or disable the automatic update function of the communication apparatus 150. Thus, the communication apparatus 150 receives an input for setting whether to enable or disable the automatic update function of the communication apparatus 150. FIG. 5 illustrates a screen 500 to be displayed in order to receive, the input. In a case where a button 501 is operated, the automatic update function of the communication apparatus 150 is to be disabled. In a case where a button 502 is operated, the automatic update function of the communication apparatus 150 is to be enabled. In a state where the automatic update function of the communication apparatus 150 is disabled, a time when the communication apparatus 150 operates in a predetermined state (described below) is not counted. The screen of FIG. 5 is displayed, for example, in a case where the communication apparatus 150 is powered on, in a case where initial setting of the communication apparatus 150 is performed, or in a case where the update of the firmware of the communication apparatus 150 is determined necessary. However, the display timing is not particularly limited. Furthermore, the setting whether to enable or disable the automatic update function of the communication apparatus 150 may not be able to be performed by the user, and the automatic update function of the communication apparatus 150 may be enabled all the time.

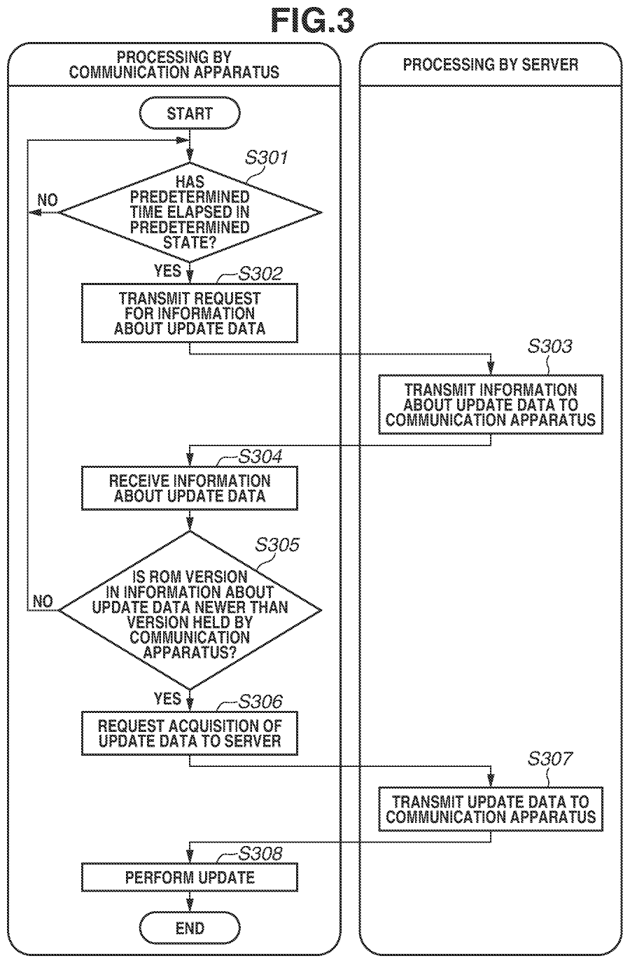

Processing performed in a state where the automatic update function of the communication apparatus 150 is enabled will be described next. FIG. 3 is a flowchart illustrating the processing performed by the communication apparatus 150 and the server 100 according to the present exemplary embodiment. The processing is implemented by the CPUs of the respective apparatuses reading out and executing various programs stored in storage areas such as the ROMs or the RAMs of the apparatuses. The processing is started when the communication apparatus 150 is powered on in the state where the automatic update function of the communication apparatus 150 is enabled. In this flowchart, communication between the communication apparatus 150 and the server 100 is performed by the network interface 151 of the communication apparatus 150 and the network interface 110 of the server 100 through the network 190.

In step S301, the communication apparatus 150 determines whether a predetermined time has elapsed in the predetermined state. In the present exemplary embodiment, in a case where the communication apparatus 150 is powered on, the communication apparatus 150 with the automatic update function enabled starts to count the time when the communication apparatus 150 operates in the predetermined state. In a case where the communication apparatus 150 is powered off or in a case where the operation in the predetermined state ends, the communication apparatus 150 stops counting the time. In other words, in a case where the communication apparatus 150 operates in a state other than the predetermined state, the communication apparatus 150 does not perform the counting. In the present exemplary embodiment, in a case where the counting is stopped, the value counted so far is reset. In other words, in step S301, it is actually determined whether the predetermined state has continued for the predetermined time. However, the configuration is not limited thereto. In a case where the counting is stopped, the value counted so far may not be reset. In other words, when the operation in the predetermined state is started again, the counting may be resumed from the value counted before the operation in the predetermined state ends. In this case, the determination is performed based on a length of the time measured by the counting. The predetermined state according to the present exemplary embodiment is a state where the communication apparatus 150 is not operated by the user. In other words, the state other than the predetermined state according to the present exemplary embodiment is at least a state where the communication apparatus 150 is operated by the user. When the communication apparatus 150 is operated by the user, the operation in the predetermined state ends. The predetermined state may be a state where the firmware is ready to be updated. Thus, in the present exemplary embodiment, the state other than the predetermined state may be at least a state where the firmware is not ready to be updated. In the present exemplary embodiment, the predetermined state further includes a state where the communication apparatus 150 does not perform printing, a state where an error does not occur in the communication apparatus 150, a state where the communication apparatus 150 does not display a specific screen, and a state where an unillustrated LED included in the communication apparatus 150 does not blink. In the present exemplary embodiment, a state satisfying all the above-described states included in the predetermined state is regarded as the predetermined state. In other words, in the present exemplary embodiment, the state other than the predetermined state is a state where at least one of the above-described states is not satisfied. For example, in a case where the communication apparatus 150 performs printing or an error occurs in the communication apparatus 150, the operation in the predetermined state ends. The predetermined state may further include a sleep state. The predetermined state is not limited thereto, and some of the above-described specific states may be included in the predetermined state, or any other state may be included in the predetermined state. Examples of an error that may occur in the communication apparatus 150 include an error caused by running out of ink or paper held by the communication apparatus 150, an error caused by shortage of the ink or the paper held. by the communication apparatus 150, and an error caused by opening of an unillustrated cover of the communication apparatus 150. Examples of the error further include an error caused by jamming of the paper in the communication apparatus 150, and an error caused by a communication failure between the communication apparatus 150 and another apparatus through the network 190. Examples of the specific screen include a network setting screen for setting the wireless connection (such as Wi-Fi connection) of the communication apparatus 150, and an error screen. Examples of the screen other than the specific screen include a home screen displaying an area of icons for performing various functions (printing, scanning, and various settings of the communication apparatus 150) which can be performed by the communication apparatus 150, and a setting screen for performing settings other than the network setting. Thus, the state where the screen other than the specific screen is displayed is regarded as the predetermined state, and the above-described counting may progress. The predetermined state is not limited to the above-described specific states. For example, any one of the above-described specific states may be treated as the predetermined state, or another state different from the above-described specific states may be treated as the predetermined state.

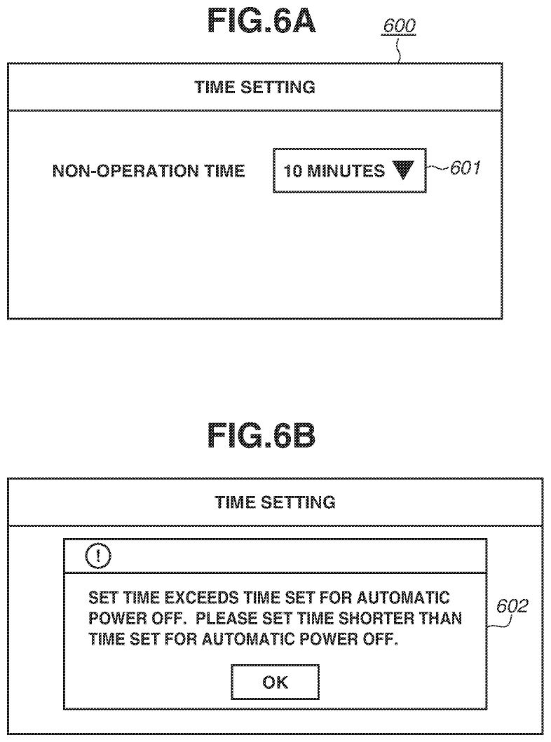

Furthermore, in the present exemplary embodiment, the predetermined time, which is a threshold time used in the determination, is set to 10 minutes. However, the predetermined time is not limited thereto. The predetermined time may be set to another value. The threshold time (the predetermined time) used in the determination may be appropriately settable by the user through an operation on the communication apparatus 150. In this case, for example, the communication apparatus 150 displays, in response to a user's operation, a screen (an input reception screen) 600 for receiving an input for changing or setting the predetermined time from the user, as illustrated in FIG. 6A. When the user operates a pull-down menu 601 on the screen 600 to select a desired time, the communication apparatus 150 sets the selected time as the predetermined time.

In a case where the communication apparatus 150 determines that the predetermined time has elapsed in the predetermined state (YES in step S301), the processing proceeds to step S302. In a case where the communication apparatus 150 determines that the predetermined time has not elapsed in the predetermined state (NO in step S301). the communication apparatus 150 repeats the determination in step S301.

In step S302, the communication apparatus 150 transmits to the server 100 a request for information about the update data. The request includes, for example, identification information of the communication apparatus 150 (e.g., information about the type of the communication apparatus 150 and information about the model number of the communication apparatus 150).

In step S303, the server 100 receives the request from the communication apparatus 150. The server 100 then identifies a piece of update data corresponding to the identification information included in the request (a piece of update data corresponding to the communication apparatus 150 having transmitted the request) from the plurality of pieces of update data held by the server 100. The server 100 then transmits information about the identified update data to the communication apparatus 150. The information about the update data includes, for example, information indicating a version of the firmware after the update using the update data, and information indicating a size of the update data. The information about the update data further includes, for example, information indicating the type and model number of the apparatus corresponding to the update data. In a case where the update data is the latest firmware, the information indicating the version of the firmware after the update using the update data is the version of the update data.

In step S304, the communication apparatus 150 receives the information about the update data, which is transmitted from the server 100 in step S303. Based on the received information, the communication apparatus 150 identifies the type and model number corresponding to the information. In a case where the identified type and model number do not correspond to the type and model number of the communication apparatus 150, the communication apparatus 150 discards the received information, and ends the processing in the flowchart of FIG. 3. In a case where the identified type and model number correspond to the type and model number of the communication apparatus 150, the processing proceeds. The information received at this time may be encrypted by the server 100. In a case where the information about the update data is encrypted, the communication apparatus 150 decrypts the received information, and checks contents of the information,

In step S305, the communication apparatus 150 checks the version indicated by the information received in step S304. The communication apparatus 150 then determines whether the checked version is newer than a version of the firmware currently held by the communication apparatus 150 (performs version determination). In a case where the communication apparatus 150 determines that the checked version is newer than the currently held version (YES in step S305), the processing proceeds to step S306. In a case where the communication apparatus 150 determines that the checked version is not newer than the currently held version (NO in step S305), the processing returns to step S301. Alternatively, in a case where the communication apparatus 150 determines that the checked version is not newer than the currently held version (NO in step S305), the processing may, for example, stand by until a predetermined operation on the communication apparatus 150 is ended, instead of returning to step S301. Then, when the operation in the predetermined state is started again, the processing may return to step S301.

In step S306, the communication apparatus 150 transmits a request for the update data to the server 100.

In step S307, the server 100 having received the request from the communication apparatus 150 transmits the update data corresponding to the communication apparatus 150, which is identified in step S303, to the communication apparatus 150. The request transmitted in step S306 also includes the identification information of the communication apparatus 150 and, in step S307, the server 100 may identify the update data corresponding to the communication apparatus 150 based on the request.

In step S308, the communication apparatus 150 receives the update data corresponding to the communication apparatus 150, which is transmitted from the server 100 in step S307, and uses the update data to start updating the firmware held by the communication apparatus 150. The update data received at this time may be encrypted by the server 100. In a case where the update data is encrypted, the communication apparatus 150 decrypts the received update data, and performs the update by using the decrypted update data. In a case where the update is completed by the processing, the communication apparatus 150 may restart upon the completion of the update. After the restart, the processing of FIG. 3 may be resumed.

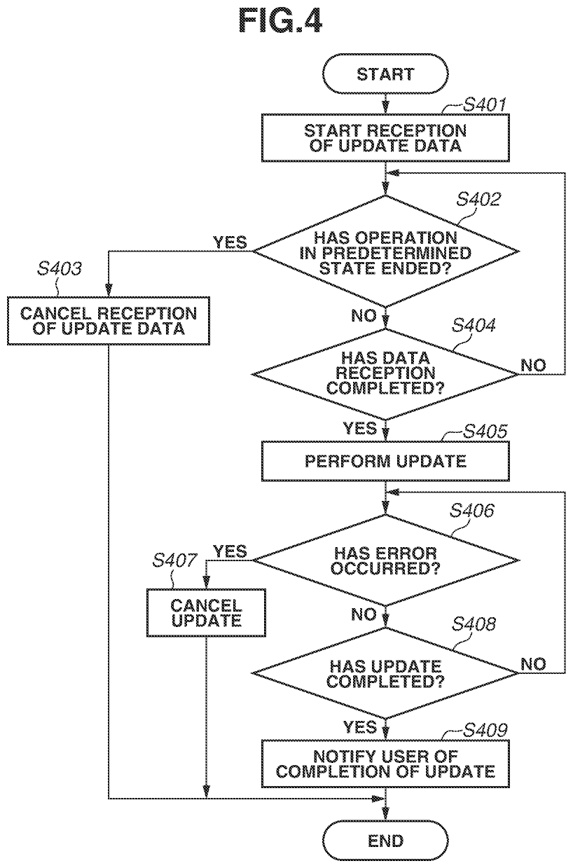

The processing in step S308 will be described in detail with reference to FIG. 4. FIG. 4 is a flowchart illustrating firmware update processing performed by the communication apparatus 150 according to the present exemplary embodiment. The processing is implemented by the CPU 156 reading out and executing various programs stored in the storage area such as the ROM 154 or the RAM 152.

In step S401, the communication apparatus 150 starts reception of the update data transmitted from the server 100. At this time, the communication apparatus 150 may display, on the display unit 160, a screen indicating that the update data is being received.

In step S402, the communication apparatus 150 determines whether the operation in the predetermined state has ended. In a case where the operation in the predetermined state ends due to, for example, a user's operation performed on the communication apparatus 150, the communication apparatus 150 determines that the operation in the predetermined state has ended (YES in step S402), and the processing proceeds to step S403. In contrast, in a case where the operation in the predetermined state continues, the communication apparatus 150 determines that the operation in the predetermined state has not ended (NO in step S402), and the processing proceeds to step S404.

In step S403, the communication apparatus 150 cancels the reception of the update data. At this time, the communication apparatus 150 may notify the server 100 of cancellation of transmission of the update data. In response to the notification, the server 100 may cancel the transmission of the update data. Furthermore, at this time, the communication apparatus 150 may return the screen displayed on the display unit 160 to the screen displayed before the screen indicating that the update data is being received. Then, the processing ends.

In step S404, the communication apparatus 150 determines whether the reception of the update data has completed. In a case where the communication apparatus 150 determines that the reception of the update data has completed (YES in step S404), the processing proceeds to step S405. In a case where the communication apparatus 150 determines that the reception of the update data has not completed (NO in step S404), the processing returns to step S402.

In step S405, the communication apparatus 150 uses the update data received from the server 100 to start updating the firmware held by the communication apparatus 150. At this time, the communication apparatus 150 may display a screen indicating that the firmware is being updated, on the display unit 160.

In step S406, the communication apparatus 150 determines whether an error has occurred during the update of the firmware. Specific examples of an error that may occur during the update of the firmware include an error caused by disconnection between the communication apparatus 150 and the network 190, and an error caused by failure of processing for writing, to the ROM 154, the data for updating the firmware. In a case where the communication apparatus 150 determines that an error has occurred during the update of the firmware (YES in step S406), the processing proceeds to step S407. In a case where the communication apparatus 150 determines that an error has not occurred during the update of the firmware (NO in step S406), the processing proceeds to step S408. Alternatively, the determination in step S406 may be a determination of whether the operation in the predetermined state has ended.

In step S407, the communication apparatus 150 cancels the update of the firmware. In this case, the firmware of the communication apparatus 150 is not to be updated, and the version remains the same as before the update. At this time, the communication apparatus 150 may return the screen displayed on the display unit 160 to the screen displayed before the screen indicating that the firmware is being updated. Then, the processing ends.

In step S408, the communication apparatus 150 determines whether the update of the firmware has completed. In a case where the communication apparatus 150 determines that the update of the firmware has completed (YES in step S408), the processing proceeds to step S409. In a case where the communication apparatus 150 determines that the update of the firmware has not completed (NO in step S408), the processing returns to step S406.

In step S409, the communication apparatus 150 notifies the user of the completion of the update of the firmware. More specifically, at this time, the communication apparatus 150 displays a screen indicating that the update of the firmware has completed, on the display unit 160. At this time, for example, the user may further be notified of information indicating the version of the firmware after the update.

Such a configuration enables the communication apparatus 150 to automatically update the firmware at an appropriate timing. For example, it is possible to prevent the user from becoming unable to use the communication apparatus 150 due to start of updating the firmware at a timing when the user is operating the communication apparatus 150. Furthermore, for example, it is possible to prevent the update of the firmware from being attempted in a state where the update of the firmware is not possible, and to complete the update more reliably.

In a second exemplary embodiment, the communication apparatus 150 has an automatic power off function. Unless otherwise specified, a configuration of a communication system according to the present exemplary embodiment is similar to the configuration of the communication system according to the first exemplary embodiment.

The automatic power off function is to determine whether a time set for the automatic power off function has elapsed since the operation in the predetermined state (to perform time determination). In a case where it is determined that the time set for the automatic power off function has elapsed since the operation in the predetermined state, the automatic power off function causes the communication apparatus 150 to automatically power off and automatically shift to a software power off state. Alternatively, the automatic power off function may automatically shift the communication apparatus 150 to a sleep state. In other words, in a case where the time set for the automatic power off function has elapsed since the operation in the predetermined state, the automatic power off function automatically shifts the communication apparatus 150 to a state that is lower in power consumption than the predetermined state. Furthermore, in the present exemplary embodiment, the user can optionally set whether to enable or disable the automatic power off function of the communication apparatus 150. In a state where the automatic power off function of the communication apparatus 150 is disabled, the time when the communication apparatus 150 operates in the predetermined state is not counted. Alternatively, the setting whether to enable or disable the automatic power off function of the communication apparatus 150 may not be able to be performed by the user, and the automatic power off function of the communication apparatus 150 may he enabled all the time.

In the following description, the predetermined time used in step S301 is referred to as a time set for the automatic update function. A threshold time for determining whether to perform the automatic power off is referred to as the time set for the automatic power off function.

In the present exemplary embodiment, in a case where the communication apparatus 150 is powered off, the counting of the time when the communication apparatus 150 operates in the predetermined state is stopped, and the value counted so far and corresponding to the operation time of the communication apparatus 150 in the predetermined state is reset. With this configuration, for example, in a case where the automatic power off function and the automatic update function of the communication apparatus 150 are enabled, and the time set for the automatic update function is longer than the time set for the automatic power off function, the automatic update function is not performed or performed less frequently.

To address this, in the present exemplary embodiment, a configuration in which control is performed to prevent the time set for the automatic update function from being longer than the time set for the automatic power off function will he described.

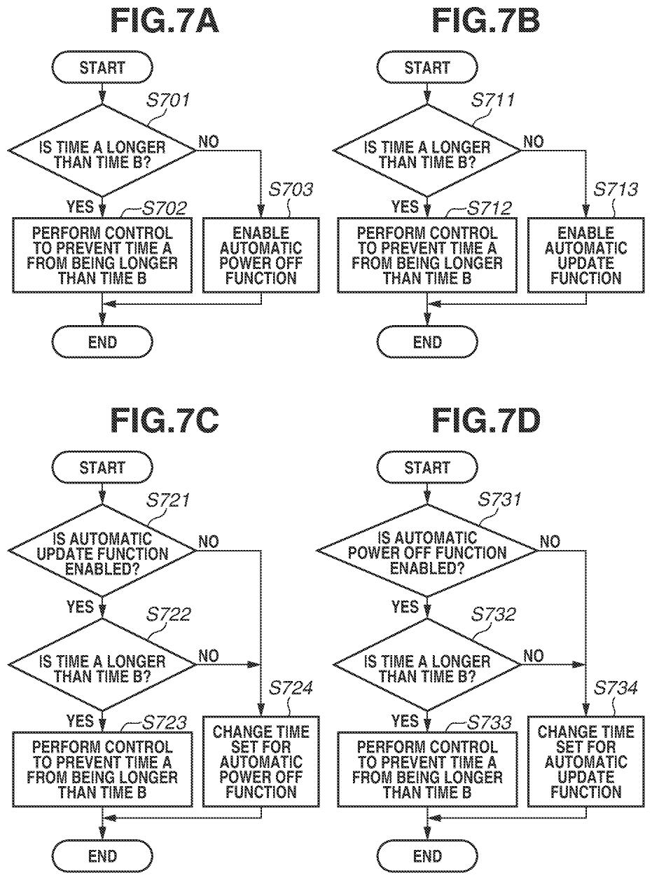

FIG. 7A is a flowchart illustrating processing performed by the communication apparatus 150 in a case where the user performs an operation to enable the automatic power off function. The processing is implemented by the CPU 156 reading out and executing various programs stored in the storage area such as the ROM 154 or the RAM 152.

In step S701, the communication apparatus 150 determines whether the time set for the automatic update function is longer than the time set for the automatic power off function, at the time when the operation to enable the automatic power off function is performed. In a case where the communication apparatus 150 determines that the time set for the automatic update function is longer than the time set for the automatic power off function (YES in step S701), the processing proceeds to step S702. In step S702, the communication apparatus 150 performs control to prevent the time set for the automatic update function from being longer than the time set for the automatic power off function. More specifically, for example, the control is processing for causing the user to change the time set for the automatic update function. In this processing, the communication apparatus 150 displays a screen such as that illustrated in FIG. 6B that includes a region 602 for notifying the user that the time set for the automatic update function exceeds the time set for the automatic power off function. Alternatively, for example, the control is processing for causing the user to change the time set for the automatic power off function. Further alternatively, for example, the control is processing in which the communication apparatus 150 automatically changes one of the time set for the automatic update function and the time set for the automatic power off function in order to prevent the time set for the automatic update function from being longer than the time set for the automatic power off function. In step S702, the automatic power off function may be enabled or may not be enabled. Alternatively, after setting is performed so that the time set for the automatic update function is not longer than the time set for the automatic power off function, the automatic power off function may be enabled. In a case where the communication apparatus 150 determines that the time set for the automatic update function is not longer than the time set for the automatic power off function (NO) in step S701), the processing proceeds to step S703. In step S703, the communication apparatus 150 enables the automatic power off function without changing the time set for the automatic update function or the time set for the automatic power off function. Then, the processing ends.

FIG. 7B is a flowchart illustrating processing performed by the communication apparatus 150 in a case where the user performs an operation to enable the automatic update function. The processing is implemented by the CPU 156 reading out and executing various programs stored in the storage area such as the ROM 154 or the RAM 152.

In step S711, the communication apparatus 150 determines whether the time set for the automatic update function is longer than the time set for the automatic power off function, at the time when the operation to enable the automatic update function is performed. In a case where the communication apparatus 150 determines that the time set for the automatic update function is longer than the time set for the automatic power off function (YES in step S711), the processing proceeds to step S712. In step S712, the communication apparatus 150 performs control to prevent the time set for the automatic update function from being longer than the time set for the automatic power off function. In step S712, the automatic update function may be enabled or may not be enabled. Alternatively, after setting is performed so that the time set for the automatic update function is not longer than the time set for the automatic power off function, the automatic update function may be enabled. in a case where the communication apparatus 150 determines that the time set for the automatic update function is not longer than the time set for the automatic power off function (NO) in step S711), the processing proceeds to step S713. In step S713, the communication apparatus 150 enables the automatic update function without changing the time set for the automatic update function or the time set for the automatic power off function. Then, the processing ends.

FIG. 7C is a flowchart illustrating processing performed by the communication apparatus 150 in a case where the user performs an operation to change the time set for the automatic power off function. In the present exemplary embodiment, the time set for the automatic power off function can be changed in a similar manner to an operation to change the time set for the automatic update function. More specifically, the communication apparatus 150 can change the time set for the automatic power off function by displaying a screen (a change input reception screen) for changing or setting the time set for the automatic power off function, and then receiving an input from the user through the screen. The processing is implemented by the CPU 156 reading out and executing various programs stored in the storage area such as the ROM 154 or the RAM 152.

In step S721, the communication apparatus 150 determines whether the automatic update function is enabled. In a case where the communication apparatus 150 determines that the automatic update function is not enabled (NO in step S721), the processing proceeds to step S724. In contrast, in a case where the communication apparatus 150 determines that the automatic update function is enabled (YES in step S721), the processing proceeds to step S722. In step S722, the communication apparatus 150 determines whether the time set for the automatic update function is longer than the time selected by the operation to change the time set for the automatic power off function. In a case where the communication apparatus 150 determines that the time set for the automatic update function is longer than the time selected by the operation (YES in step S722), the processing proceeds to step S723. In step S723, the communication apparatus 150 performs control to prevent the time set for the automatic update function from being longer than the time set for the automatic power off function. In a case where the communication apparatus 150 determines that the time set for the automatic update function is not longer than the time selected by the operation (NO in step S722), the processing proceeds to step S724. In step S724, the communication apparatus 150 newly sets the time selected by the operation for the automatic power off function (i.e., changes the time set for the automatic power off function to the selected time). Then, the processing ends.

FIG. 7D is a flowchart illustrating processing performed by the communication apparatus 150 in a case where the user performs an operation to change the time set for the automatic update function (e.g., an operation to select a desired. time by operating the pull-down menu 601 of the screen 600). The processing is implemented by the CPU 156 reading out and executing various programs stored in the storage area such as the ROM 154 and the RAM 152.

In step S731, the communication apparatus 150 determines whether the automatic power off function is enabled. In a case where the communication apparatus 150 determines that the automatic power off function is not enabled (NO in step S731), the processing proceeds to step S734. In contrast, in a case where the communication apparatus 150 determines that the automatic power off function is enabled (YES in step S731), the processing proceeds to step S732. In step S732, the communication apparatus 150 determines whether the time selected by the operation to change the time set for the automatic update function is longer than the time set for the automatic power off function. In a case where the communication apparatus 150 determines that the time selected by the operation is longer than the time set for the automatic power off function (YES in step S732), the processing proceeds to step S733. In step S733, the communication apparatus 150 performs control to prevent the time set for the automatic update function from being longer than the time set for the automatic power off function, In a case where the communication apparatus 150 determines that the time selected by the operation is not longer than the time set for the automatic power off function (NO in step S732), the processing proceeds to step S734. In step S734, the communication apparatus 150 newly sets the time selected by the operation for the automatic update function (i.e., changes the time set for the automatic update function to the selected time). Then, the processing ends.

The above-described processing makes it possible to prevent the time set for the automatic update function from exceeding the time set for the automatic power off function, and to prevent the automatic update function from not being performed or being performed less frequently.

The configuration in which the communication apparatus 150 is connected to the network 190 has been described above. However, for example, there may be a configuration in which the communication apparatus 150 is connected to an information processing apparatus such as a PC connected to the network 190 and is not directly connected to the network 190. In this case, the communication apparatus 150 may perform communication, including communication of the update data and the information about the update data, with the server 100 through the information processing apparatus such as a PC.

Furthermore, for example, assume that the communication apparatus 150 has the automatic power off function and the threshold time for determining whether to perform the automatic power off is settable from a plurality of options. In this case, a fixed value smaller than the smallest of the values settable as the threshold time for determining whether to perform the automatic power off may be set in advance as the threshold time for determining whether to perform the automatic update function. Furthermore, for example, assume that both the threshold time for determining whether to perform the automatic power off and the threshold time for determining whether to perform the automatic update function are settable from a plurality of options. In this case, control may be performed so that all the options settable as the threshold time for determining whether to perform the automatic update function are smaller than the smallest of the values settable as the threshold time for determining whether to perform the automatic power off.

While the case where the firmware of the communication apparatus 150 is updated has been described above, the program to be updated is not limited to the firmware and another program held by the communication apparatus 150 may be updated. The program to be updated may be, for example, an application program held by the communication apparatus 150.

While the configuration in which the automatic update function counts the time when the communication apparatus 150 operates in the predetermined state and does not count the time when the communication apparatus 150 does not operate in the predetermined state has been described above, the configuration is not limited thereto. For example, the automatic update function may count the time when the communication apparatus 150 operates in a power-on state, irrespective of whether the communication apparatus 150 operates in the predetermined state. In this case, if the counted time exceeds the predetermined time, it is determined whether the communication apparatus 150 operates in the predetermined state. If it is determined that the communication apparatus 150 operates in the predetermined state, the processing for updating the firmware of the communication apparatus 150 may be performed. If it is determined that the communication apparatus 150 does not operate in the predetermined state, the processing for updating the firmware of the communication apparatus 150 may not be performed at a timing when the counted time exceeds the predetermined time. Thereafter, in the case where the communication apparatus 150 operates in the predetermined state, the processing for updating the firmware of the communication apparatus 150 may be performed. Such control enables the firmware of the communication apparatus 150 to be updated at an appropriate timing.

The above-described exemplary embodiments are also implemented by supplying a program for implementing the functions according to the above-described exemplary embodiments to a system or an apparatus through a network or various storage media, and causing a computer (e.g., a CPU or a micro-processing unit (MPU)) of the system or the apparatus to read out and execute the program. The program may be executed by one computer or a plurality of computers cooperating with one another. In addition, all of the above-described processing is not necessarily implemented by software, and a part or all of the processing may be implemented by hardware such as an application specific integrated circuit (ASIC). Furthermore, all of the processing may not be performed by one CPU, and may be performed by a plurality of CPUs appropriately cooperating with one another.

According to the exemplary embodiments of the present disclosure, it is possible to perform the processing for more appropriately updating the program held by the communication apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-197652, filed Nov. 27, 2020, which is hereby incorporated by reference herein in its entirety.

What is claimed is:

1. A printing apparatus including a predetermined program, the printing apparatus comprising:
a reception unit configured to receive at least one of a setting to enable an automatic update function or a setting to disable the automatic update function, wherein the automatic update function is a function causing the printing apparatus to automatically update the predetermined program; and
an update unit configured to, in a case where the setting to enable the automatic update function is received, automatically update the predetermined program on the basis that a version of the predetermined program is not a latest version and that a predetermined state where the printing apparatus does not perform a predetermined function continues for a predetermined time, and configured to, in a case where the setting to disable the automatic update function is received, not automatically update the predetermined program.

2. The printing apparatus according to claim 1, further comprising:
a count unit configured to count a time when the predetermined state continues; and
a determination unit configured to determine whether the predetermined state continues for the predetermined time, based on the counted time,
wherein, in the case where the setting to enable the automatic update function is received, the predetermined program is automatically updated on the basis that the version of the predetermined. program is not the latest version and that the predetermined state is determined to continue for the predetermined time.

3. The printing apparatus according to claim 2, wherein, in a case where the predetermined state ends, the counted time is reset.

4. The printing apparatus according to claim 2, wherein, in the case where the setting to disable the automatic update function is received, the time when the predetermined state continues is not counted.

5. The printing apparatus according to claim 1, further comprising a control unit configured to shift the printing apparatus to a power saving state on the basis that the predetermined state continues for a specific time,
wherein the printing apparatus has lower power consumption in the power saving state than the predetermined state.

6. The printing apparatus according to claim 1, further comprising:
an operation reception unit configured to receive at least one of an operation to change a time set as the predetermined time or an operation to change a time set as the specific time; and
a processing unit configured to perform predetermined processing for preventing the time set as the predetermined time from being longer than the time set as the specific time, on the basis that the time set as the predetermined time is longer than the time set as the specific time.

7. The printing apparatus according to claim 6, wherein the predetermined processing is processing for changing at least one of the time set as the predetermined time or the time set as the specific time.

8. The printing apparatus according to claim 6, wherein the predetermined processing is processing for prompting a user to change at least one of the time set as the predetermined time or the time set as the specific time.

9. The printing apparatus according to claim 6, further comprising a time determination unit configured to determine whether the time set as the predetermined time is longer than the time set as the specific time,
wherein the predetermined processing is performed on the basis that the time set as the predetermined time is determined to he longer than the time set as the specific time.

10. The printing apparatus according to claim 9, wherein the time determination unit determines whether the time set as the predetermined time is longer than the time set as the specific time, based on the reception of at least one of the operation to change the time set as the predetermined time or the operation to change the time set as the specific time.

11. The printing apparatus according to claim I, wherein the predetermined function is at least one of a printing function or a function of displaying a specific screen.

12. The printing apparatus according to claim 11, wherein the specific screen is a network setting screen for setting wireless connection of the printing apparatus.

13. The printing apparatus according to claim 1, wherein the predetermined state is a state where no error occurs in the printing apparatus.

14. The printing apparatus according to claim 1, further comprising a reception unit configured to receive update data for updating the predetermined program, from a server outside the printing apparatus,
wherein the predetermined program is updated based on the update data.

15. The printing apparatus according to claim 14, wherein the update data is received on the basis that the version of the predetermined program is not the latest version and that the predetermined state continues for the predetermined time.

16. The printing apparatus according to claim 1, further comprising:
an information reception unit configured to receive information about the latest version from a server outside the printing apparatus; and
a version determination unit configured to determine whether the version of the predetermined program is the latest version, based on the received information about the latest version.

17. The printing apparatus according to claim 1, wherein the predetermined program is firmware.

18. The printing apparatus according to claim 1, wherein the printing apparatus is an inkjet printer.

19. A method for controlling a printing apparatus including a predetermined program, the method comprising:
receiving at least one of a setting to enable an automatic update function or a setting to disable the automatic update function, wherein the automatic update function is a function causing the printing apparatus to automatically update the predetermined program; and
in a case where the setting to enable the automatic update function is received, automatically updating the predetermined program on the basis that a version of the predetermined program is not a latest version and that a predetermined state where the printing apparatus does not perform a predetermined function continues for a predetermined time, and in a case where the setting to disable the automatic update function is received, not automatically updating the predetermined program.

20. A non-transitory computer-readable storage medium storing a program for causing a computer of a printing apparatus including a predetermined program to perform a method comprising:
receiving at least one of a setting to enable an automatic update function or a setting to disable the automatic update function, wherein the automatic update function is a function causing the printing apparatus to automatically update the predetermined program; and
in a case where the setting to enable the automatic update function is received, automatically updating the predetermined program on the basis that a version of the predetermined program is not a latest version and that a predetermined state where the printing apparatus does not perform a predetermined function continues for a predetermined time, and in a case where the setting to disable the automatic update function is received, not automatically updating the predetermined program.
